(19) United States
(12) Patent Application Publication
(10) Pub. No.: US 2020/0339410 A1
(43) Pub. Date: Oct. 29, 2020

(54) LIGHTWEIGHT COMPOSITE FRAME FOR HORSE SADDLES

(71) Applicants: William T. Robinson, Boulder, CO (US); Kevin Dunne, Lakewood, CO (US)

(72) Inventors: William T. Robinson, Boulder, CO (US); Kevin Dunne, Lakewood, CO (US)

(21) Appl. No.: 16/857,317

(22) Filed: Apr. 24, 2020

Related U.S. Application Data
(60) Provisional application No. 62/838,855, filed on Apr. 25, 2019.

(51) Int. Cl. B68C 1/02

(52) U.S. Cl. CPC B68C 1/025; B68F 1/00

(57) ABSTRACT

Embodiments include a composite saddle tree that is lighter than traditional saddle trees due to its substantially synthetic construction, but retains the functionality of a traditional saddle tree due to its inclusion of at least one accessory engagement member in at least one location where support and/or fastening mechanisms (e.g., screws, pegs, pins, adhesive, and the like) are normally secured. The composite saddle tree is made up of a saddle tree core having at least one depression in which the at least one accessory engagement member is disposed. A reinforcing material covers an outer surface of the saddle tree core.

### CROSS-REFERENCE TO RELATED APPLICATIONS

This application claims the benefit of U.S. Provisional Application Ser. No. 62/838,855, filed on Apr. 25, 2019, which is incorporated by reference herein in its entirety for all purposes.

### TECHNICAL FIELD

Embodiments of the present disclosure relate to saddling equipment for riding animals. More specifically, the present disclosure relates to saddle trees constructed using composite materials for use in the manufacture of riding saddles for horses, for example.

### BACKGROUND

Riding saddles are commonly made by stretching a leather covering over a rigid framework referred to as a saddle tree. The saddle tree thus defines the shape of the saddle, both conforming to the curvature of the horse's back and evenly distributing the weight of the user over a large surface area. Saddle trees also provide a supporting structure for the variety of saddling equipment that may be attached to the saddle tree, including skirts, stirrups, and straps. Saddle trees may benefit from strength to withstand heavy use during horse-related activities such as roping, equine speed events, and training.

Traditional saddle trees are made from wood, steel, or a combination thereof; however, saddle trees made from such materials often produce saddles that are extremely heavy. A heavy saddle is cumbersome for both horse and rider, making it difficult for smaller riders to lift the saddle onto a horse's back without assistance and slowing horses down in competitive speed-based events. The extra weight can also contribute to injury of young horses during training.

Alternative materials and fabrication methods for saddle trees have been proposed, such as the use of solid plastics that are cast- or injection-molded. However, saddle trees made from such materials are often just as heavy or heavier than traditional designs. Another proposed alternative is the use of low-density materials such as rigid foam or lightweight wood, but such materials on their own are often not strong enough to retain the nails, screws, or other support and/or fastening mechanisms used to secure the leather and rigging to the saddle tree.

Although relatively specific problems may be discussed, it should be understood that the examples should not be limited to solving the specific problems identified in this section or elsewhere in this disclosure.

### BRIEF SUMMARY

Some embodiments of the present disclosure relate to providing a lightweight, durable saddle tree that is comfortable for a horse to wear and simple for a user to lift onto a horse's back and secure to the horse. Specifically, some embodiments relate to a composite saddle tree that is lighter than saddle trees made exclusively from wood, steel, or solid plastic, but is made stronger and more functional than other saddle trees made exclusively from low-density materials by the placement of at least one accessory engagement member in at least one location where support and/or fastening mechanisms are normally secured. The at least one accessory engagement member may therefore support localized loads and distribute such loads more broadly across the saddle tree core and into the outer reinforcing material. The composite saddle trees retain substantially the same shape as traditional saddle trees, allowing both saddle manufacturers and users to interact with such composite saddle trees in substantially the same manner as they would with traditional saddle trees.

For example, some embodiments of the composite saddle tree include a saddle tree core, an accessory engagement member, and a fiber-reinforced plastic reinforcing material. In some embodiments, these components are combined to create a composite saddle tree that is lightweight overall and reinforced only where necessary to support the leather and rigging that will be attached to the saddle tree to construct a saddle. The saddle tree core may include a pommel, a cantle, a seat, and a bar; one or more of the bar or pommel including at least one depression in which the at least one accessory engagement member is disposed. The application of the reinforcing material to an outer surface of the saddle tree core strengthens the saddle tree, and the manner in which the reinforcing material is applied allows for customization of flexibility and stiffness in particular locations and directions.

### BRIEF DESCRIPTION OF THE DRAWINGS

The accompanying figures illustrate one or more embodiments of the present disclosure and, together with the detailed description, serve to explain aspects and implementations of a composite saddle tree. In the appended figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label. Embodiments are described in conjunction with the appended figures:

FIG. 1 is a perspective view of the composite saddle tree, with the at least one accessory engagement member, according to an embodiment of the present disclosure;

FIG. 2 is a perspective view of the composite saddle tree, with the first and second bar, according to an embodiment of the present disclosure;

FIG. 3 is a partially exploded top view of the composite saddle tree, illustrating the reciprocal relationship between the plurality of accessory engagement members and the plurality of depressions, according to an embodiment of the present disclosure;

FIG. 4 is a cross-sectional view of the composite saddle tree of FIG. 3, taken along dotted line A of FIG. 3 and facing in the direction indicated by the accompanying arrows;

FIG. 5 is a cross-sectional view of the composite saddle tree of FIG. 3, taken from box B in FIG. 4, illustrating the overlapping relationship between the outer surface of the saddle tree core and the proximate and outer layers of the reinforcing material;

FIG. 6 is a top view of the composite saddle tree of FIG. 3, illustrating the positional relationship between the support and/or fastening mechanisms and the plurality of accessory engagement members;

FIG. 7 is a side view of the composite saddle tree of FIG. 1;

FIG. 8 is a bottom view of the composite saddle tree of FIG. 2;

FIG. 9 is a front view of the pommel, illustrating the positional relationship between the first and second pommel portions and the horn, according to an embodiment of the present disclosure;

FIG. 10 is an exploded perspective view of the reinforcing material, illustrating the overlapping relationship between the proximate and outer layers as well as the perpendicular alignment of the proximate and outer fibers, according to an embodiment of the present disclosure;

FIG. 11 is a front view of the composite saddle tree of FIG. 2; and

FIG. 12 is a cross-sectional view of the first bar of the composite saddle tree of FIG. 2, taken along dotted line C of FIG. 11 and facing in the direction indicated by the accompanying arrows.

Specific embodiments are shown by way of example in the drawings and are described in detail below. The intention, however, is not to limit the disclosure to the particular embodiments described or shown. On the contrary, the disclosure is intended to cover modifications, equivalents, and alternatives falling within the scope of the invention as defined by the disclosure and the claims.

### DETAILED DESCRIPTION

All illustrations of the drawings are for the purpose of describing selected embodiments and are not intended to limit the scope of the claims. The ensuing detailed description provides exemplary embodiments, and is not intended to limit the scope, applicability, or configuration of the disclosure. Rather, the ensuing detailed description of exemplary embodiments will provide those skilled in the art with an enabling description for implementing one or more exemplary embodiments. It should be understood that various changes may be made in the function and arrangement of elements without departing from the spirit and scope of the invention as set forth in the claims.

The following specification describes embodiments of a lightweight composite saddle tree with the ability to support the nails, screws, or other support and/or fastening mechanisms that are used to secure leather and rigging to the composite saddle tree in the construction of a saddle. In one embodiment, the composite saddle tree is comprised primarily of lightweight, synthetic materials, but also incorporates at least one accessory engagement member in at least one location where such mechanisms are normally secured. In other embodiments, the composite saddle tree may be comprised primarily of fiber-reinforced plastic, wood, solid plastic, or rigid foam. In general commercial applications, fiber-reinforced plastic most commonly includes fiberglass, aramid fiber, or carbon fiber in a matrix of epoxy, vinyl ester, or polyester.

A saddle tree core 102 forms the basic structure for the composite saddle tree 100, the saddle tree core 102 comprising at least one depression 312a in which at least one accessory engagement member 112 is disposed. The saddle tree core 102 itself is comprised of a first material 120a which may be a rigid foam, while the at least one accessory engagement member 112 is comprised of a second material 120b that is denser than the first material 120a and which may be one or more of wood, metal, thermosetting polymer, or thermoplastic polymer. The composite saddle tree 100 is further comprised of a reinforcing material 414 covering an outer surface 402a of the saddle tree core 102. The reinforcing material 414 may be one or more plies of fiber-reinforced plastic, and such fibers may be one or more of carbon fiber, fiberglass, or aramid fiber.

In one embodiment, the saddle tree core 102 is comprised of a pommel 104, a cantle 106, a seat 108, and a bar 110. The various components of the saddle tree core 102 are attached to each other by support and/or fastening mechanisms 616 (e.g., screws, pegs, pins, adhesive, and the like). The pommel 104 and the cantle 106 are disposed at front and back portions of the bar 110, respectively, while the seat 108 spans the distance between the pommel 104 and the cantle 106 in one direction and side portions of the bar 110 in another direction. At least one depression 312a is disposed in the bar 110, and at least one accessory engagement member 112 is disposed in the at least one depression 312a. An outer surface 402a of the saddle tree core 102 is covered by a reinforcing material 414. The reinforcing material 414 comprises a plurality of layers such that a first portion of the reinforcing material 414 forms a proximate layer 514a in direct contact with the outer surface 402a, and a second portion of the reinforcing material 414 forms an outer layer 514b in direct contact with the proximate layer 514a. The proximate layer 514a and the outer layer 514b comprise fibers in a polymer matrix, the proximate layer 514a including proximate fibers 1018a and the outer layer 514b comprising outer fibers 1018b oriented with some angle relative to the alignment of the proximate fibers 1018a.

In another embodiment, the saddle tree core 102 is comprised of a pommel 104, a cantle 106, a seat 108, a first bar 210a, and a second bar 210b. The first bar 210a is adjacent to the second bar 210b and is parallel to and opposite the second bar 210b. The pommel 104 is disposed at first ends of the first bar 210a and the second bar 210b, spanning the distance between such first ends. The cantle 106 is disposed at second ends of the first bar 210a and the second bar 210b, spanning the distance between such second ends. The seat 108 is disposed between the first bar 210a and the second bar 210b in one direction and the pommel 104 and cantle 106 in another direction. A plurality of depressions 312a are disposed in the first and second ends of the first bar 210a and the second bar 210b, and a plurality of accessory engagement members 212 are disposed in the plurality of depressions 312a.

In another embodiment, the pommel 904 is comprised of a first pommel portion 904a, a second pommel portion 904b, and a horn 904c. The various components of the pommel 904 are attached to each other by support and/or fastening mechanisms 616. In some embodiments, the first pommel portion 904a and the second pommel portion 904b are comprised of a first material 120a, which may be a rigid foam, and the horn 904c is comprised of a second material 120b that is denser than the first material 120a and which may be one or more of wood, metal, thermosetting polymer, or thermoplastic polymer.

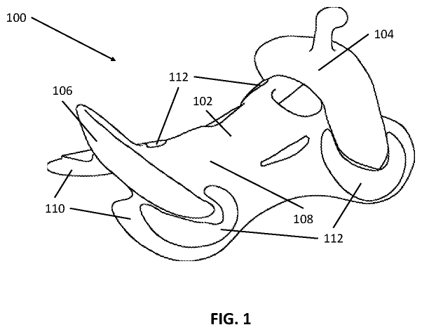

FIG. 1 is a perspective view of an embodiment of the present disclosure. The composite saddle tree 100 is comprised of a saddle tree core 102, itself comprised of a pommel 104, a cantle 106, a seat 108, and a bar 110. The pommel 104 is disposed at a front portion of the bar 110 and the cantle 106 is disposed at a back portion of the bar 110. The seat 108 is disposed between the pommel 104, the cantle 106, and the bar 110, spanning the distance between the pommel 104 and the cantle 106 in one direction and side portions of the bar 110 in another direction. At least one accessory engagement member 112 is disposed in one or more of the front, back, or side portions of the bar 110.

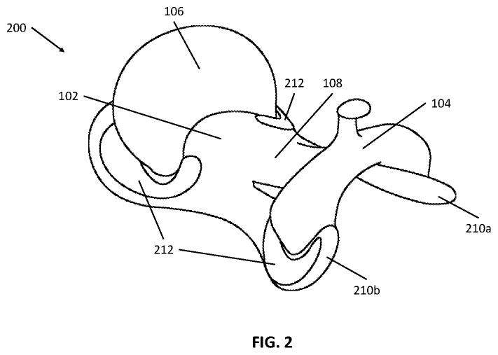

FIG. 2 is a perspective view of an embodiment of the present disclosure. The composite saddle tree 200 is comprised of a saddle tree core 102, itself comprised of a pommel 104, a cantle 106, a seat 108, a first bar 210a, and a second bar 210b. The first bar 210a is adjacent to the second bar 210b and is parallel to and opposite the second bar 210b. The pommel 104 is disposed at first ends of the first bar 210a and the second bar 210b. The cantle 106 is disposed at second ends of the first bar 210a and the second bar 210b. The seat 108 is disposed between the pommel 104 and the cantle 106, spanning the distance between the pommel 104 and the cantle 106 in one direction and the first bar 210a and the second bar 210b in another direction. A plurality of accessory engagement members 212 are disposed in one or more of the first or second ends of the first bar 110a and the second bar 110b.

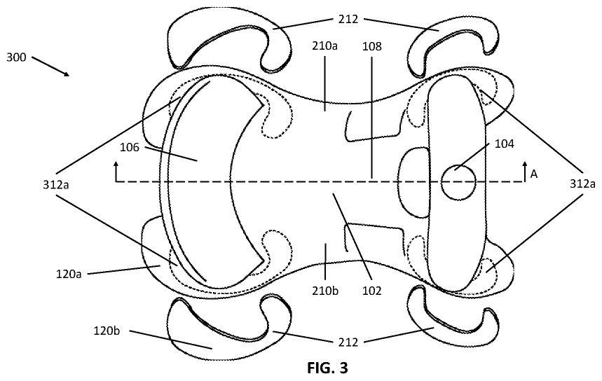

FIG. 3 is a partially exploded top view of an embodiment of the present disclosure. The composite saddle tree 300 is comprised of a saddle tree core 102, itself comprised of a pommel 104, a cantle 106, a seat 108, a first bar 210a, and a second bar 210b. A plurality of depressions 312a are disposed at one or more of the first or second ends of the first bar 210a and the second bar 210b, and a plurality of accessory engagement members 212 are disposed in the plurality of depressions 312a. The saddle tree core 102 is comprised of a first material 120a, while the plurality of accessory engagement members 212 are comprised of a second material 120b that is denser than the first material 120a. The first material 120a may be a rigid foam and the second material 120b may be one or more of wood, metal, thermosetting polymer, or thermoplastic polymer.

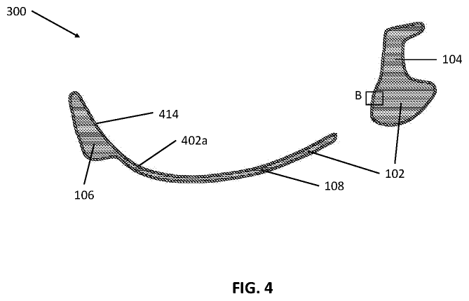

FIG. 4 is a cross-sectional view of the composite saddle tree 300 of FIG. 3, taken along line A of FIG. 3 and facing in the direction of the accompanying arrows. This view shows the pommel 104, the cantle 106, and the seat 108 of the saddle tree core 102. A reinforcing material 414 covers an outer surface 402a of the saddle tree core 102.

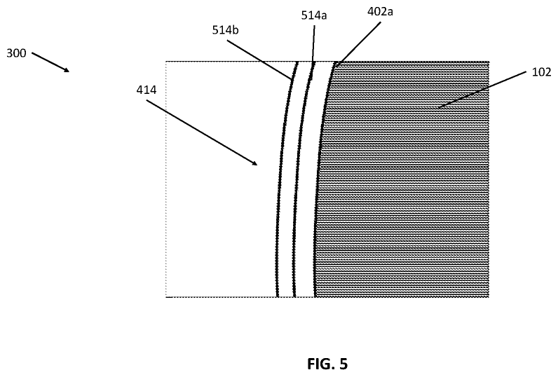

FIG. 5 is a cross-sectional view of the composite saddle tree 300 of FIG. 3, taken from box B in FIG. 4. The reinforcing material 414 is comprised of a plurality of layers such that a first portion of the reinforcing material 414 forms a proximate layer 514a in direct contact with the outer surface 402a of the saddle tree core 102, and a second portion of the reinforcing material 414 forms an outer layer 514b in direct contact with the proximate layer 514a, according to some embodiments.

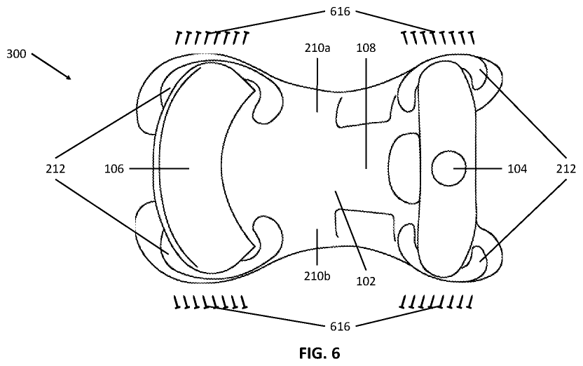

FIG. 6 is a partially exploded top view of the composite saddle tree 300 of FIG. 3. This view shows support and/or fastening mechanisms 616 in locations where such mechanisms are normally secured. The plurality of accessory engagement members 212 are disposed in such locations to support various accessories that are normally attached to a saddle while it is being constructed. Thus, such accessories may be attached to the composite saddle tree 300 at such locations using support and/or fastening mechanisms 616 to construct a saddle.

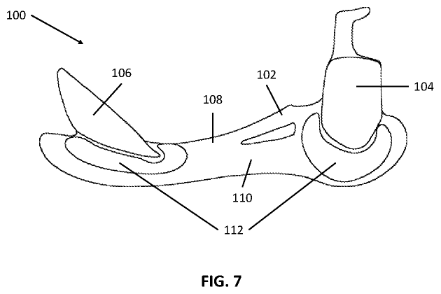

FIG. 7 is a side view of the composite saddle tree 100 of FIG. 1. This view shows the saddle tree core 102, including the pommel 104, the cantle 106, the seat 108, and the bar 110, as well as the at least one accessory engagement member 112.

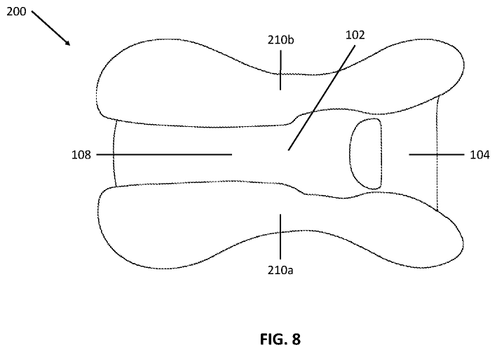

FIG. 8 is a bottom view of the composite saddle tree 200 of FIG. 2. This view shows the saddle tree core 102, including the pommel 104, the seat 108, the first bar 210a, and the second bar 210b.

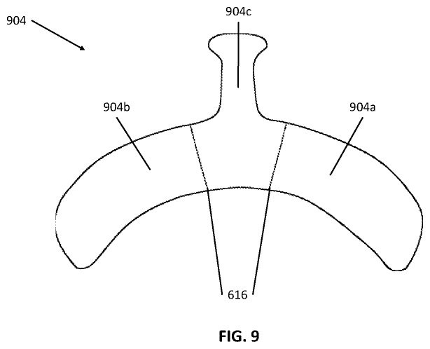

FIG. 9 is a front view of the pommel 904 of some embodiments of the present disclosure. The various components of the pommel 904 are attached to each other by support and/or fastening mechanisms 616. The pommel 904 is comprised of a first pommel portion 904a, a second pommel portion 904b opposite the first pommel portion 904a, and a horn 904c disposed between the first pommel portion 904a and the second pommel portion 904b.

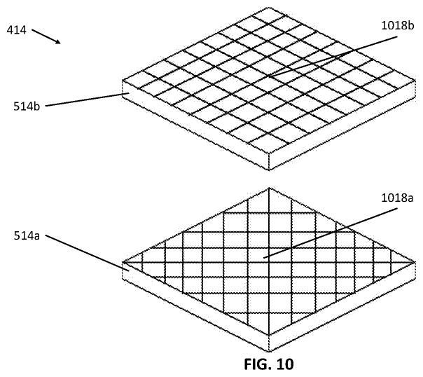

FIG. 10 is an exploded perspective view of the reinforcing material 414 of some embodiments of the present disclosure. The reinforcing material 414 is comprised of a plurality of layers such that a first portion of the reinforcing material 414 forms a proximate layer 514a and a second portion of the reinforcing material 414 forms an outer layer 514b. The proximate layer 514a comprises proximate fibers in a polymer matrix with fibers 1018a aligned with each other in a substantially perpendicular weave or braid and the outer layer 514b comprises outer fibers 1018b aligned with each other in a substantially perpendicular weave or braid. The proximate fibers 1018a and the outer fibers 1018b are oriented such that the outer fibers 1018b are misaligned with the proximate fibers 1018a by some angle. The angle at which the proximate fibers 1018a and the outer fibers 1018b are aligned allows for some localized customization of stiffness, durability, and flexibility.

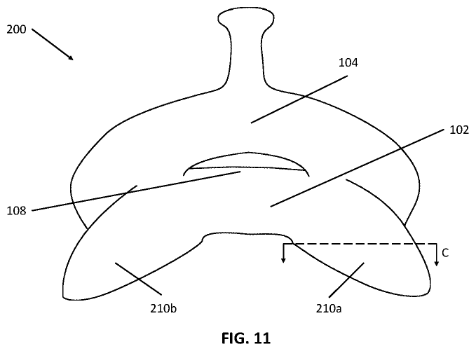

FIG. 11 is a front view of the composite saddle tree 200 of FIG. 2. This view shows the saddle tree core 102, including the pommel 104, the seat 108, the first bar 210a, and the second bar 210b.

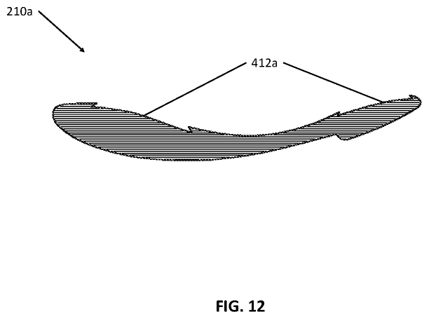

FIG. 12 is a cross-sectional view of the first bar 210a of FIG. 2, taken along line C of FIG. 11 and facing in the direction of the accompanying arrows. This view shows a plurality of depressions 412a disposed at the first and second ends of the first bar 210a.

While a number of aspects and embodiments have been discussed above, persons having ordinary skill in the art will recognize certain modifications, permutations, additions, and equivalents may alternatively be used or introduced. It is intended that the scope of the following claims be interpreted to include all such modifications, permutations, additions, and equivalents. The terms and expressions used herein are for description, not limitation, and there is no intention to exclude any equivalents of the aspects shown and described. In addition, any workable combination of the features and elements disclosed herein can be employed.

Having described several embodiments, it will be recognized by those of skill in the art that various modifications, alternative constructions, and equivalents may be used without departing from the spirit of the disclosure. Additionally, a number of well-known processes and elements have not been described in order to avoid unnecessarily obscuring the present disclosure. Accordingly, the above description should not be taken as limiting the scope of the disclosure.

What is claimed is:

1. A composite saddle tree comprising:
a saddle tree core comprised of a first material, the saddle tree core comprising a depression;
an accessory engagement member disposed in the depression, the accessory engagement member comprised of a second material that is denser than the first material; and
a reinforcing material covering an outer surface of the saddle tree core and the accessory engagement member.

2. The composite saddle tree of claim 1, wherein the first material is one or more of low-density wood or rigid foam.

3. The composite saddle tree of claim 1, wherein the second material is one or more of wood, metal, thermosetting polymer, or thermoplastic polymer.

4. The composite saddle tree of claim 1, wherein the reinforcing material covers the outer surface of the saddle tree core such that a first portion of the reinforcing material forms a proximate layer in direct contact with the outer surface, and a second portion of the reinforcing material forms an outer layer in direct contact with the proximate layer.

5. The composite saddle tree of claim 4, wherein the reinforcing material further comprises at least one additional portion, the at least one additional portion forming at least one partial layer in direct contact with the outer layer.

6. The composite saddle tree of claim 1, wherein the reinforcing material comprises fibers aligned in a weave or braid.

7. The composite saddle tree of claim 1, wherein the reinforcing material forms a plurality of layers such that the fibers of each alternating layer are aligned in an angled relationship.

8. The composite saddle tree of claim 1, wherein the reinforcing material is one or more of fiberglass, aramid fiber, or carbon fiber and is contained in a matrix of one or more of epoxy, vinyl ester, or polyester.

9. A composite saddle tree comprising:
a saddle tree core comprised of a first material, the saddle tree core comprising:
a pommel;
a cantle;
a seat;
a bar comprising at least one depression; and
at least one accessory engagement member disposed in the at least one depression, the at least one accessory engagement member comprised of a second material that is denser than the first material; and
a reinforcing material covering an outer surface of the saddle tree core and the at least one accessory engagement member.

10. The composite saddle tree of claim 9, wherein the bar further comprises a first and second end, the at least one depression disposed at one or more of the first and second ends of the bar.

11. The composite saddle tree of claim 9, wherein the bar further comprises a first and second end, the at least one depression is disposed at one or more of the first and second ends of the bar, the pommel is disposed at the first end of the bar, and the cantle is disposed at the second end of the bar.

12. The composite saddle tree of claim 9, wherein the pommel comprises a first pommel member, a second pommel member, and a horn.

13. The composite saddle tree of claim 9, wherein the pommel comprises a first pommel member, a second pommel member, and a horn, the horn comprised of the second material or a third material that is denser than the first material.

14. The composite saddle tree of claim 9, wherein the first material is one or more of low-density wood or rigid foam.

15. The composite saddle tree of claim 9, wherein the second material is one or more of wood, metal, thermosetting polymer, and thermoplastic polymer.

16. The composite saddle tree of claim 9, wherein the reinforcing material is one or more of fiberglass, aramid fiber, or carbon fiber and is contained in a matrix of one or more of epoxy, vinyl ester, or polyester.

17. The composite saddle tree of claim 9, wherein the reinforcing material covers the outer surface of the saddle tree core such that a first portion of the reinforcing material forms a proximate layer in direct contact with the outer surface of the saddle tree core, and a second portion of the reinforcing material forms an outer layer in direct contact with the proximate layer.

18. The composite saddle tree of claim 17, wherein the reinforcing material further comprises at least one additional portion, the at least one additional portion forming at least one partial layer in direct contact with the outer layer.

19. The composite saddle tree of claim 9, wherein the reinforcing material comprises fibers aligned in a weave or braid.

20. The composite saddle tree of claim 9, wherein the reinforcing material forms a plurality of layers such that the fibers of each alternating layer are aligned in an angled relationship.
